(19) United States
(12) Patent Application Publication
(10) Pub. No.: US 2026/0030191 A1
(43) Pub. Date: Jan. 29, 2026

(54) SYSTEM AND METHODS FOR DYNAMIC MIGRATION OF ENDPOINTS ACROSS PCIe HOSTS

(71) Applicant: Microchip Touch Solutions Limited, Wokingham (GB)

(72) Inventors: Prasanna Vengateshan Varadharajan, Chennai (IN); Richard Cannon, Frodsham, Cheshire (GB); Pragash Mangalapandian, Chennai (IN); Atish Ghosh, Austin, TX (US)

(73) Assignee: Microchip Touch Solutions Limited, Wokingham (GB)

(21) Appl. No.: 19/026,746

(22) Filed: Jan. 17, 2025

(30) Foreign Application Priority Data
Jul. 25, 2024 (IN) 202411056687

(51) Int. Cl. G06F 13/40; G06F 9/50; G06F 13/42

(52) U.S. Cl. CPC G06F 13/4022; G06F 9/5005; G06F 13/4282; G06F 2213/0026

(57) ABSTRACT

A system includes a PCIe switch coupled to one or more hosts and coupled to one or more PCIe endpoints. In operation, the one or more PCIe endpoints may be attached to the PCIe switch and the PCIe switch may determine hardware and software resources of respective one or more PCIe endpoints. The PCIe switch may allocate the hardware and software resources in a primary partition and a backup partition. In cases where communication is lost between the PCIe switch and at least one of the one or more hosts, one or more of the PCIe endpoints may migrate between a primary partition and a backup partition.

### PRIORITY

This application claims priority to commonly owned Indian Provisional Patent Application No. 202411056687 filed on Jul. 25, 2024, the entire contents of which are hereby incorporated by reference for all purposes.

### FIELD OF THE INVENTION

The present disclosure relates to a system and method for dynamic migration of endpoints across Peripheral Component Interconnect Express (PCIe) hosts.

### BACKGROUND

In high-reliability PCIe systems, one of a plurality of hosts may be responsible for handling specific functions of a system including Advanced Driving Assistance Systems (ADAS) and Infotainment systems and may be termed a primary host. A PCIe system may include one or more primary hosts. Another host providing a failover function may be designated as a backup host. In the event that communication is lost between a primary host and a PCIe switch, responsibility for the failover functions of the system must be migrated to a backup host. This process can be complicated, time consuming and prone to error.

In secure PCIe systems, one of a plurality of hosts may be responsible for active functions and safety processing functions for the PCIe system and may be termed the safety host. The safety host may perform safety related checks for the PCIe devices and may migrate them to one of a plurality of primary hosts.

A host may be one or more of a primary host, safety host, backup host.

In addition, if communication is lost to any host coupled to a PCIe switch, any PCIe endpoints attached to the host which has lost communication must be migrated to another host. Existing solutions may require additional configuration at the time of communication loss, which may result in interruption to the system.

There is a need for systems and methods to enable dynamic migration of PCIe hosts and endpoints.

### SUMMARY

The examples herein enable a system and method for dynamic migration of endpoints across hosts.

According to one aspect, a device includes a PCIe switch coupled to at least one primary host and coupled to at least one backup host. The PCIe switch includes a plurality of partitions, respective partitions comprising at least one upstream port and at least one downstream port. The PCIe switch includes a primary partition coupled to the at least one primary host and a backup partition coupled to the at least one backup host. The device includes one or more PCIe endpoints attached to the PCIe switch. The PCIe switch may migrate at least one of the one or more PCIe endpoints between the primary partition and the backup partition based on a predetermined condition. The migration may include at least one transition between a first state and a second state. The first state may be communication between the at least one of the one or more PCIe endpoints and the primary host. The second state may be communication between the at least one of the one or more PCIe endpoints and the backup host.

According to one aspect, a system includes a plurality of hosts, the plurality of hosts including at least a first host configured as a primary host and a second host configured as a backup host. The system may include a PCIe switch coupled to the plurality of hosts. The system may include a PCIe switch comprising a processor and a plurality of partitions, including at least a primary partition coupled to the first host and a backup partition coupled to the second host. Respective partitions comprise at least one upstream port and at least one downstream port. The system may include one or more PCIe endpoints attached to the PCIe switch. The PCIe switch may include instructions on a non-transitory machine-readable medium, the instructions, when read and executed by the processor, to cause the processor to migrate the one or more PCIe endpoints between the primary partition and the backup partition based on a predetermined condition. The migration may include at least one transition between a first state and a second state. The first state may be communication between the one or more PCIe endpoints and the first host. The second state may be communication between the one or more PCIe endpoints and the second host.

According to one aspect, a method includes steps of: enumerating, in a PCIe switch, one or more PCIe endpoints attached to the PCIe switch, determining a primary partition and a backup partition for respective one or more PCIe endpoints, determining hardware and software resources for respective PCIe endpoints of the one or more PCIe endpoints attached to the PCIe switch and allocating hardware and software resources within respective partitions within the PCIe switch, attaching at least one PCIe endpoint to the primary partition, and migrating at least one PCIe endpoint between the primary partition and the backup partition based on a network condition.

### BRIEF DESCRIPTION OF THE DRAWINGS

FIG. 1 illustrates one of various examples of a system for dynamic migration of endpoints across PCIe hosts.

FIG. 2 illustrates a method of dynamic migration of endpoints across PCIe hosts.

### DETAILED DESCRIPTION

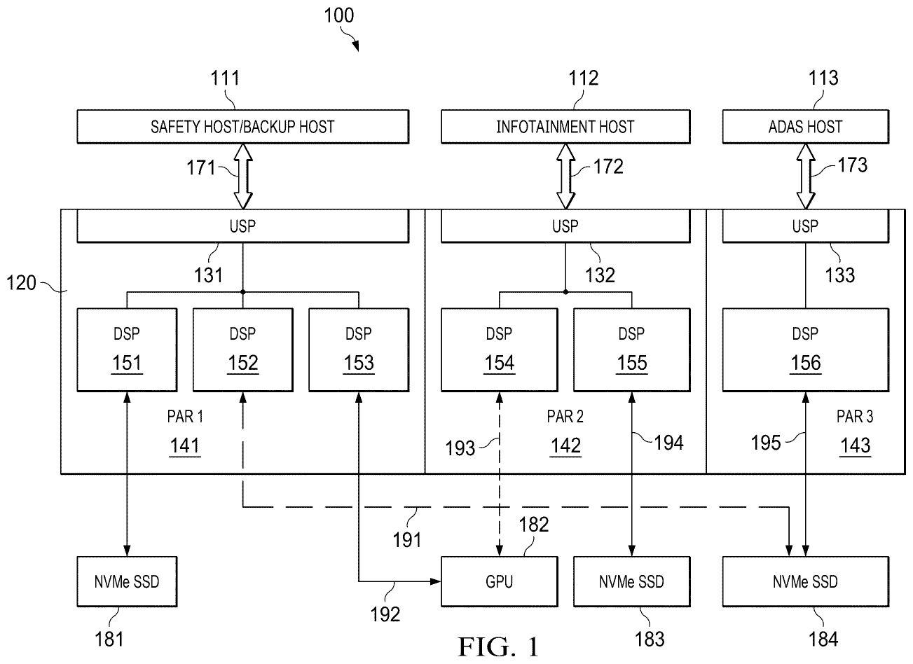

FIG. 1 illustrates one of various examples of a system 100 for dynamic migration of endpoints across a PCIe host.

System 100 may include a first host 111, a second host 112 and a third host 113. First host 111 may be a safety host, and may also be termed a backup host. Second host 112 may be an infotainment host. Third host 113 may be an Automated Driver Assistance System (ADAS) host. First host 111, second host 112 and third host 113 may be other types of hosts not specifically mentioned. The example of FIG. 1 includes three hosts, but this is not intended to be limiting.

First host 111 may be a system-on-a-chip (SoC), a central processing unit (CPU) or another type of processor or controller not specifically mentioned. Second host 112 may be a system-on-a-chip (SoC), a central processing unit (CPU) or another type of processor or controller not specifically mentioned. Third host 113 may be a system-on-a-chip (SoC), a central processing unit (CPU) or another type of processor or controller not specifically mentioned.

Second host 112 and third host 113 may be configured as primary hosts. When communication with a primary host is lost, communication of PCIe endpoints may be established with a backup host. A system may include multiple primary hosts. A system may include more hosts than the hosts illustrated in FIG. 1 or may include fewer hosts than the hosts illustrated in FIG. 1.

The example illustrated in FIG. 1 is for illustrative purposes and should not be interpreted as limiting. Any host may be a safety host or primary host or backup host. First host 111 is not required to be a backup host.

System 100 may include first memory 181, second memory 183 and third memory 184. First memory 181 may be a Non-Volatile Memory Express (NVMe) memory. First memory 181 may be a solid-state drive (SSD). First memory 181 may be another type of memory not specifically mentioned. Second memory 183 may be an NVMe memory. Second memory 183 may be a solid-state drive (SSD). Second memory 183 may be another type of memory not specifically mentioned. Third memory 184 may be an NVMe memory. Third memory 184 may be a solid-state drive (SSD). Third memory 184 may be another type of memory not specifically mentioned. PCIe endpoints 181, 182, 183 and 184 illustrated in FIG. 1 are for illustrative purposes and should not be interpreted as limiting. PCIe endpoints 181, 182, 183 and 184 may be any type of PCIe device not limited to memory devices or processors.

First host 111 may be coupled to PCIe switch 120 at first upstream port 131. First host 111 and PCIe switch 120 may communicate utilizing the PCIe communication protocol as indicated at connection 171. Second host 112 may be coupled to PCIe switch 120 at second upstream port 132. Second host 112 and PCIe switch 120 may communicate utilizing the PCIe communication protocol as indicated at connection 172. Third host 113 may be coupled to PCIe switch 120 at third upstream port 133. Third host 113 and PCIe switch 120 may communicate utilizing the PCIe communication protocol as indicated at connection 173.

PCIe switch 120 may be configured to include multiple partitions. PCIe switch 120 may include first partition 141, second partition 142 and third partition 143. In the example illustrated in FIG. 1, PCIe switch 120 includes three partitions, but this is not intended to be limiting.

First partition 141 may include first upstream port 131. First upstream port 131 may communicate with first host 111. In one of various examples, first host 111 may be a safety host and first partition 141 may be a safety partition. First host 111 may be a backup host. First partition 141 may include first downstream port 151, second downstream port 152 and third downstream port 153. First downstream port 151 may be coupled to first memory 181. Second downstream port 152 may be coupled to third memory 184. Third downstream port 153 may be attached to graphics processing unit (GPU) 182.

Second partition 142 may include second upstream port 132. Second upstream port 132 may communicate with second host 112. In one of various examples, second host 112 may be an Advanced Driver Assist System (ADAS) host. Second host 112 may be a primary host. Second partition 142 may include fourth downstream port 154 and fifth downstream port 155. Fourth downstream port 154 may be attached to GPU 182. Fifth downstream port 155 may be attached to second memory 183. In one of various examples, second host 112 may be configured as a primary host.

Third partition 143 may include third upstream port 133. Third upstream port 133 may communicate with third host 113. In one of various examples, third host 113 may be an infotainment host. Third host 113 may be a primary host. Third partition 143 may include sixth downstream port 156. Sixth downstream port 156 may be attached to third memory 184.

In operation, during an attachment and enumeration operation, PCIe switch 120 may allocate resource requirements for all endpoints attached to PCIe switch 120. PCIe switch 120 may communicate with one or more PCIe endpoints during enumeration and may allocate resource requirements as determined during enumeration. Enumeration and determination of hardware and software resource requirements may occur at the time the one or more PCIe endpoints attach to PCIe switch 120.

The example illustrated in FIG. 1 includes three hosts, three upstream ports, and six downstream ports, but this is not intended to be limiting. Other examples may include a different number of hosts, upstream ports and downstream ports.

In operation, PCIe switch 120 may enumerate endpoints attached to PCIe switch 120. During enumeration, PCIe switch 120 may determine resource requirements of all endpoints attached to PCIe switch 120. Resource requirements may include Base Address Register (BAR) size and location, and Memory Mapped Input/Output (MMIO) requirements. PCIe switch 120 may designate a backup host. If communication with a primary host is lost, PCIe switch 120 may migrate endpoints attached to the partition coupled to a primary host to be attached to the partition attached to a backup host, based on the resource requirements determined previously.

In one of various examples, graphics processing unit (GPU) 182 may be attached to PCIe switch 120. In operation, first host 111 may be configurated as a safety host. During attachment and enumeration, PCIe switch 120 may communicate with GPU 182 and may determine resource requirements of GPU 182 and may authenticate GPU 182 as a component authorized to access system 100 and to communicate with PCIe switch 120. PCIe switch 120 may allocate hardware and software resources within first partition 141 and second partition 142. Hardware and software resource may include, without limitation, memory, processors, bus interfaces and input/output circuits. Once resource requirements have been determined, and optionally once authentication of GPU 182 completed within first partition 141 as illustrated by path 192, PCIe switch 120 may migrate GPU 182 to fourth downstream port 154. GPU 182 may communicate with PCIe switch at fourth downstream port 154 in a first state as shown by path 193.

In one of various examples, second memory 183 may be attached to PCIe switch 120. Second memory 183 may be a solid-state drive. In operation, first host 111 may be configurated as a safety host. During attachment and enumeration, PCIe switch 120 may communicate with second memory 183 and may determine resource requirements of second memory 183 and may authenticate second memory 183 as a component authorized to access system 100 and to communicate with PCIe switch 120. PCIe switch 120 may allocate hardware and software resources within second partition 142. Hardware and software resource may include, without limitation, memory, processors, bus interfaces and input/output circuits. Once resource requirements have been determined, and optionally once authentication of second memory 183 completed, PCIe switch 120 may migrate second memory 183 to fifth downstream port 155. Second memory 183 may communicate with PCIe switch 120 at fifth downstream port 155 as shown by path 194.

In one of various examples, third memory 184 may be attached to third partition 143 and may communicate with third host 113. First host 111 may be configured as a safety host, and may be configured as a backup host for third memory 184. During attachment and enumeration of third memory 184, PCIe switch 120 may allocate resources for third memory 184 in second downstream port 152 and in sixth downstream port 156. After enumeration, third memory 184 may be migrated to third partition 143. Third memory 184 may communicate with PCIe switch 120 at sixth downstream port 156 in a first state, as illustrated by path 195. During operation, third host 113 may lose communication with PCIe switch 120. Based on this loss of communication, PCIe switch 120 may migrate third memory 184 from third partition 143 to first partition 141 and may attach third memory 184 to second downstream port 152 in a second state as illustrated by path 191. PCIe switch 120 may communicate with third memory 184 via first partition 141 in the second state. As the PCIe switch allocated resource requirements for third memory 184 to both second downstream port 152 and sixth downstream port 156, PCIe switch 120 may migrate third memory 184 from third partition 143 to first partition 141 without the need for any additional enumeration or configuration. After communication between PCIe switch 120 and third host 113 has been restored, PCIe switch 120 may migrate third memory 184 from first partition 111 back to third partition 143 and PCIe switch 120 may communication with third memory 184 in the first state.

PCIe switch 120 may include a processor, and the processor may execute instructions to implement the enumeration of the one or more PCIe endpoints and to allocate resources in first partition 141, second partition 142 and third partition 143. The processor may, based on a network condition, migrate one or more PCIe endpoints between a primary partition and a backup partition. The processor may migrate one or more PCIe endpoints from a primary partition to a backup partition and may migrate one or more PCIe endpoints from a backup partition to a primary partition. In one of various examples, the network condition may include a loss of communication between a host and the PCIe switch, a re-established communication between a host and the PCIe switch, an increase of link error rate above a threshold, a decrease of link error rate below a threshold, or a success or failure of authentication.

PCIe switch 120 may include a non-transitory machine-readable medium which may comprise instructions, the instructions to be executed by a processor and to control communication in PCIe switch 120.

Path 191 and path 193 are illustrated as dashed lines, but this is merely for ease of readability and is not intended to imply these paths are unclaimed elements.

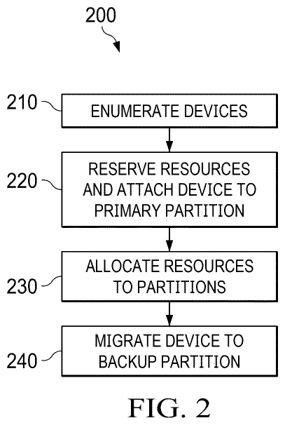

FIG. 2 illustrates a method of dynamic migration of PCIe endpoints across PCIe hosts.

At operation 210, a PCIe switch may enumerate one or more PCIe endpoints attached to the PCIe switch and may determine hardware and software resources for respective PCIe endpoints attached to the PCIe switch.

At operation 220, the PCIe switch may determine a primary partition and a backup partition for respective PCIe endpoints. A primary host may be coupled to a primary partition. A backup host may be coupled to a backup partition.

At operation 230, the PCIe switch may determine resource requirements of respective PCIe endpoints and may allocate resources within respective backup partitions and respective primary partitions for respective PCIe endpoints and may attach respective PCIe endpoints to respective primary partitions in a first state.

At operation 240, the PCIe switch may migrate a PCIe endpoint between a primary partition and a backup partition in a second state, the migration based on a network condition. In one of various examples, the network condition may comprise a loss of communication with a primary partition.

1. A device comprising:
a PCIe switch coupled to at least one primary host and coupled to at least one backup host, the PCIe switch comprising a plurality of partitions, respective partitions comprising at least one upstream port and at least one downstream port, and comprising a primary partition coupled to the at least one primary host and a backup partition coupled to the at least one backup host;
one or more PCIe endpoints attached to the PCIe switch; and
wherein the PCIe switch to migrate at least one of the one or more PCIe endpoints between the primary partition and the backup partition based on a predetermined condition, the migration comprising at least one transition between a first state and a second state, the first state comprising communication between the at least one of the one or more PCIe endpoints and the primary host and the second state comprising communication between the at least one of the one or more PCIe endpoints and the backup host.

2. The device as claimed in claim 1, the PCIe switch to attach at least one of the one or more PCIe endpoints to a downstream port in the primary partition.

3. The device as claimed in claim 1, the PCIe switch to determine hardware and software resources of at least one PCIe endpoint of the one or more PCIe endpoints.

4. The device as claimed in claim 3, the PCIe switch to determine hardware and software resources of the respective one or more PCIe endpoints at the time respective PCIe endpoints attach to the PCIe switch.

5. The device as claimed in claim 3, the hardware and software resources comprising at least one of memory-mapped input/output requirements, number of Base Address Registers (BARs) and size of BARs.

6. The device as claimed in claim 3, the PCIe switch to allocate one or more resources to the primary partition and to the backup partition based on the determined hardware and software resource requirements, the one or more resources to be allocated by the PCIe switch during enumeration.

7. The device as claimed in claim 1, the predetermined condition comprising a loss of communication between the primary host and the PCIe switch.

8. A system comprising:
a plurality of hosts, comprising at least a first host configured as a primary host and a second host configured as a backup host;
a PCIe switch coupled to the plurality of hosts, the PCIe switch comprising a processor and a plurality of partitions, including at least a primary partition coupled to the first host and a backup partition coupled to the second host, wherein respective partitions comprise at least one upstream port and at least one downstream port;
one or more PCIe endpoints attached to the PCIe switch; and
wherein the PCIe switch comprises instructions on a non-transitory machine-readable medium, the instructions, when read and executed by the processor, cause the processor to migrate the one or more PCIe endpoints between the primary partition and the backup partition based on a predetermined condition, the migration comprising at least one transition between a first state and a second state, a first state comprising communication between the one or more PCIe endpoints and the first host and a second state comprising communication between the one or more PCIe endpoints and the second host.

9. The system as claimed in claim 8, the predetermined condition comprising one or more of a loss of communication between the first host and the PCIe switch, a re-established communication between a first host and the PCIe switch, an increase of link error rate above a threshold, a decrease of link error rate below a threshold, and a success or failure of authentication.

10. The system as claimed in claim 8, the PCIe switch to determine hardware and software resource requirements of the respective PCIe endpoints at the time respective PCIe endpoints attach to the PCIe switch.

11. The system as claimed in claim 10, the hardware and software resource requirements comprising at least one of memory-mapped input/output requirements, number of BARs and size of BARs.

12. The system as claimed in claim 8, the processor to migrate the one or more PCIe endpoints between the primary partition and the backup partition based on a predetermined condition, the migration comprising at least one transition between the second state and the first state, a first state comprising communication between the one or more PCIe endpoints and the first host and a second state comprising communication between the one or more PCIe endpoints and the second host.

13. The system as claimed in claim 12, the predetermined condition comprising a restoration of communication between the first host and at least one of the PCIe endpoints.

14. A method comprising:
enumerating, in a PCIe switch, one or more PCIe endpoints attached to the PCIe switch;
determining a primary partition and a backup partition for respective one or more PCIe endpoints;
determining hardware and software resources for respective PCIe endpoints of the one or more PCIe endpoints attached to the PCIe switch and allocating hardware and software resources within respective partitions within the PCIe switch;
attaching at least one PCIe endpoint to the primary partition; and
migrating at least one PCIe endpoint between the primary partition and the backup partition based on a network condition.

15. The method as claimed in claim 14, the hardware and software resource requirements comprising at least one of memory-mapped input/output requirements, number of Base Address Registers (BARs) and size of BARs.

16. The method as claimed in claim 14, the allocating hardware and software resources comprising allocating memory resources to respective partitions.

17. The method as claimed in claim 14, the network condition comprising one or more of a loss of communication between the PCIe switch and a primary host, a re-established communication between a primary host and the PCIe switch, an increase of link error rate above a threshold, a decrease of link error rate below a threshold, or a success or failure of authentication.
